(19) United States
(12) Patent Application Publication
(10) Pub. No.: US 2025/0207991 A1
(43) Pub. Date: Jun. 26, 2025

(54) PRESSURE SENSOR DEVICE AND METHOD OF MANUFACTURING PRESSURE SENSOR DEVICE

(71) Applicant: FUJI ELECTRIC CO., LTD., Kawasaki-shi (JP)

(72) Inventor: Hiroto KIKUCHI, Matsumoto-city (JP)

(73) Assignee: FUJI ELECTRIC CO., LTD., Kawasaki-shi (JP)

(21) Appl. No.: 18/934,214

(22) Filed: Oct. 31, 2024

(30) Foreign Application Priority Data
Dec. 22, 2023 (JP) 2023-217458

(51) Int. Cl. G01L 19/14; G01L 9/00; G01L 19/00; G01L 19/06

(52) U.S. Cl. CPC G01L 19/147; G01L 9/0042; G01L 19/0084; G01L 19/0627

(57) ABSTRACT

A pressure sensor device, comprising: a sensor unit having a sensor chip having a diaphragm, the sensor chip being configured to convert pressure caused by deformation of the diaphragm into an electrical signal, and a member supporting the sensor chip; and a resin case housing the sensor unit. The sensor unit is so disposed that a bottom surface thereof faces the resin case with an adhesive disposed therebetween. The bottom surface of the sensor unit has a center region and a peripheral region that are mutually exclusive. The center region of the bottom surface of the sensor unit is fixed to the resin case by the adhesive between the center region and the resin case, and the peripheral region of the bottom surface of the sensor unit is not fixed to the resin case by the adhesive between the peripheral region and the resin case.

### CROSS REFERENCE TO RELATED APPLICATIONS

This application is based upon and claims the benefit of priority of the prior Japanese Patent Application No. 2023-217458, filed on Dec. 22, 2023, the entire contents of which are incorporated herein by reference.

### BACKGROUND OF THE INVENTION

### 1. Field of the Invention

Embodiments of the present disclosure relate to a pressure sensor device and a method of manufacturing a pressure sensor device.

### 2. Description of the Related Art

Conventionally, a pressure sensor device has a configuration in which a pressure sensor unit is housed in a concave sensor mounting portion formed in a resin case body. The pressure sensor unit has a structure in which a pressure sensor chip is bonded to a glass pedestal and the glass pedestal is adhered to a bottom of a resin case (for example, refer to Japanese Laid-Open Patent Publication No. 2018-155632). Further, as a technique to enhance accuracy and reduce deformation of a pressure sensor unit caused by differences in the linear expansion coefficients of the pressure sensor unit, a resin case, and an adhesive due to temperature change, a method has been proposed in which a region to be fixed by an adhesive is smaller than a diaphragm of a sensor chip. (for example, refer to Japanese Laid-Open Patent Publication No. 2019-109196).

### SUMMARY OF THE INVENTION

According to an embodiment of the present disclosure, a pressure sensor device includes: a sensor unit having: a sensor chip having a diaphragm, the sensor chip being configured to convert pressure caused by deformation of the diaphragm into an electrical signal, and a member supporting the sensor chip; and a resin case housing the sensor unit,. The sensor unit is so disposed that a bottom surface thereof faces the resin case with an adhesive disposed therebetween. The bottom surface of the sensor unit has a center region and a peripheral region that are mutually exclusive. The center region of the bottom surface of the sensor unit is fixed to the resin case by the adhesive between the center region and the resin case. The peripheral region of the bottom surface of the sensor unit is not fixed to the resin case by the adhesive between the peripheral region and the resin case.

Objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a cross-sectional view depicting a structure of a semiconductor pressure sensor device according to an embodiment.

FIG. 2 is a cross-sectional view depicting the structure of the semiconductor pressure sensor device according to the embodiment.

FIG. 3 is a plan view depicting a layout when the semiconductor pressure sensor device in FIGS. 1 and 2 is viewed from a top thereof.

FIG. 4 is a cross-sectional view schematically depicting a state of a semiconductor pressure sensor device of a first example during manufacture.

FIG. 5 is a cross-sectional view schematically depicting a state of the semiconductor pressure sensor device of the first example during manufacture.

FIG. 6 is a cross-sectional view schematically depicting a state of the semiconductor pressure sensor device of the first example during manufacture.

FIG. 7 is a cross-sectional view schematically depicting a state of the semiconductor pressure sensor device of the first example during manufacture.

FIG. 8 is a cross-sectional view schematically depicting a state of a semiconductor pressure sensor device of a second example during manufacture.

FIG. 9 is a cross-sectional view schematically depicting a state of the semiconductor pressure sensor device of the second example during manufacture.

FIG. 10 is a cross-sectional view schematically depicting a state of the semiconductor pressure sensor device of the second example during manufacture.

FIG. 11 is a cross-sectional view depicting a structure of a conventional semiconductor pressure sensor device.

FIG. 12 is a cross-sectional view depicting the structure of the semiconductor pressure sensor device in which a region to be fixed by a conventional adhesive is made smaller.

### DETAILED DESCRIPTION OF THE INVENTION

First, problems associated with the conventional techniques are discussed. In a conventional pressure sensor device, a problem arises in that air bubbles occur in a gap between the resin case and a bottom surface of the sensor unit; and the air bubbles grow, thereby compressing and severing wiring that connects the sensor chip and the case.

With consideration of such problems, a pressure sensor device according to the present disclosure has the following features. The pressure sensor device includes a sensor unit having a sensor chip that converts pressure due to deformation of a diaphragm into an electrical signal, and a member supporting the sensor chip; and a resin case housing the sensor unit. A bottom surface of the sensor unit and the resin case are fixed to each other by an adhesive, and at the bottom surface of the sensor unit and the resin case: a center region of the bottom surface of the sensor unit is fixed to the resin case by the adhesive, and a region excluding the center region of the bottom surface of the sensor unit has the adhesive but is not fixed to the resin case by the adhesive.

According to the disclosure above, the pressure sensor unit and the resin case are constrained only in a small region of the region center portion and thus, thermal stress due to the linear expansion difference between the pressure sensor unit and the resin case due to temperature variation is reduced and deformation of the diaphragm of the pressure sensor unit is reduced. Thus, deterioration of the accuracy of the sensor may be suppressed. The occurrence of air bubbles during gel application is eliminated and the possibility that a defect such as wire breakage occurs post-market due to growth of the air bubbles caused application of pressure, etc. may be reduced.

Further, in the pressure sensor device according to the present disclosure, in the disclosure above, the region where the sensor unit is not fixed to the resin case by the adhesive may be a region of the bottom surface of the sensor unit where a mold release agent is applied.

Further, in the pressure sensor device according to the present disclosure, in the disclosure above, the region where the sensor unit is not fixed to the resin case by the adhesive may be a region of a bottom of the resin case where a mold release agent is applied.

Further, in the pressure sensor device according to the present disclosure, in the disclosure above, the mold release agent contains a fluororesin as a main constituent.

Further, in the pressure sensor device according to the present disclosure, in the disclosure above, an area of a region where the resin case and the sensor unit are fixed to each other by the adhesive is at least 5% of an area of the bottom surface of the sensor unit facing the bottom of the resin case but not more than 200% of an area of the diaphragm.

A method of manufacturing a pressure sensor device according to the present disclosure has the following features. The method is a method of manufacturing a pressure sensor device that includes a sensor unit having a sensor chip that converts pressure due to deformation of a diaphragm into an electrical signal, and a member that supports the sensor chip; and a resin case housing the sensor unit. First, a first process is performed, the first process including applying a mold release agent only to a peripheral portion of a bottom surface of the sensor unit. Next, a second process is performed, the second process including applying an adhesive of a predetermined amount to a bottom of the resin case or the bottom surface of the sensor unit. Next, a third process is performed, the third process including mounting the sensor unit at a predetermined position in the resin case, applying a predetermined temperature with the adhesive being present in an entire area between the bottom surface of the sensor unit and the bottom of the resin case and thereby curing the adhesive. Next, a fourth process is performed, the fourth process including connecting the sensor unit and a lead terminal of the resin case by a bonding wire. Next, a fifth process is performed, the fifth process including injecting a protective gel into the resin case. Next, a sixth process is performed, the sixth process including exposing the resin case to a vacuum environment and thereby defoaming the protective gel. Next, a seventh process is performed, the seventh process including applying a predetermined temperature to the resin case and thereby curing the protective gel.

A method of manufacturing a pressure sensor device according to the present disclosure has the following features. The method is a method of manufacturing a pressure sensor device that includes a sensor unit having a sensor chip that converts pressure due to deformation of a diaphragm into an electrical signal, and a member that supports the sensor chip; and a resin case housing the sensor unit. A first process is performed, the first process including applying a mold release agent only to a peripheral portion of a bottom of the resin case facing a bottom surface of the sensor unit. Next, a second process is performed, the second process including applying a predetermined amount of an adhesive to the bottom of the resin case or the bottom surface of the sensor unit. Next, a third process is performed, the third process including mounting the sensor unit at a predetermined position in the resin case, applying a predetermined temperature with the adhesive being present in an entire area between the bottom surface of the sensor unit and the bottom of the resin case and thereby curing the adhesive. Next, a fourth process is performed, the fourth process including connecting the sensor unit and a lead terminal of the resin case by a bonding wire. Next, a fifth process is performed, the fifth process including injecting a protective gel into the resin case. Next, a sixth process is performed, the sixth process including exposing the resin case to a vacuum environment and thereby defoaming the protective gel. Next, a seventh process is performed, the seventh process including applying a predetermined temperature to the resin case and thereby curing the protective gel.

Further, in the method of manufacturing the pressure sensor device according to the present disclosure, in the disclosure above, a region of a center portion of the bottom surface of the sensor unit free of the mold release agent is in a range of at least 5% of an area of the bottom surface of the sensor unit facing the bottom of the resin case but not more than 200% of an area of the diaphragm.

Further, in the method of manufacturing the pressure sensor device according to the present disclosure, in the disclosure above, a region of a center portion of a region of the bottom of the resin case facing the bottom surface of the sensor unit and being free of the mold release agent is in a range of at least 5% of an area of the bottom surface of the sensor unit facing the bottom of the resin case but not more than 200% of an area of the diaphragm.

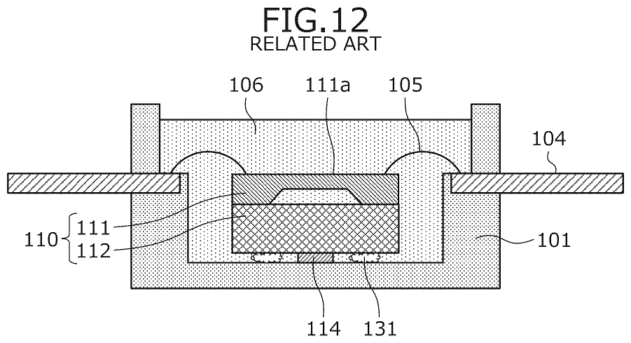

Here, problems associated with a conventional semiconductor pressure sensor device are discussed. A conventional semiconductor pressure sensor device is described with reference to the accompanying drawings. FIG. 11 is a cross-sectional view depicting a structure of the conventional semiconductor pressure sensor device. The semiconductor pressure sensor device includes a pressure sensor unit 110 configured by a semiconductor pressure sensor chip 111 and a pedestal member 112, a resin case 101 formed of a thermoplastic resin such as polyphenylene sulfide (PPS), polybutylene terephtalate (PBT), etc., lead terminals 104, a gel 106, and an adhesive 114.

In the semiconductor pressure sensor chip 111, a diaphragm structure is formed on a silicon substrate and on the diaphragm structure, multiple semiconductor distortion gauges made of a material having a piezoresistive effect are bridge-connected. The semiconductor pressure sensor chip 111 is bonded to the pedestal member 112 in a vacuum, a vacuum reference chamber is formed in a portion surrounded by a diaphragm 111a and the pedestal member 112. In the pressure sensor unit 110, the resistance of the semiconductor distortion gauges changes according to the pressure applied to the diaphragm 111a, and the amount of change is output as an electrical signal.

The pressure sensor unit 110 is fixed inside the resin case 101 by the adhesive 114. Further, the pressure sensor unit 110 is electrically connected to the lead terminals 104 by bonding wires 105. Further, the resin case 101 is filled with the protective gel 106, whereby the semiconductor pressure sensor chip 111, the bonding wires 105, etc. are protected from a pressure medium.

Assembly of the semiconductor pressure sensor device having the configuration like that described is generally by a method including applying the adhesive 114 to the resin case 101, mounting the pressure sensor unit 110 on the adhesive 114 and thereafter, heating and curing the adhesive 114. Because there is a difference in the linear expansion coefficient between the resin case 101 and the pressure sensor unit 110, which is made of silicon and glass, when heating is performed to a temperature T and the adhesive 114 is cured, for example, at room temperature, assembly stress corresponding to a difference in temperature from the temperature T occurs. Such stress caused by temperature change leads to deformation of the pressure sensor unit 110 and the accuracy of the sensor output decreases.

Thus, in Japanese Laid-Open Patent Publication No. 2019-109196, as described, as a measure to reduce deformation of the pressure sensor unit 110 caused by differences in linear expansion coefficients of the pressure sensor unit 110, the resin case 101, and the adhesive 114 due to temperature changes and as a measure to enhance accuracy, a method of making the region to be fixed by the adhesive 114 smaller than the diaphragm 111a of the semiconductor pressure sensor chip 111 is proposed. FIG. 12 is a cross-sectional view depicting the structure of the semiconductor pressure sensor device in which the region to be fixed by a conventional adhesive is made smaller.

In the semiconductor pressure sensor device, by fixing only a small region in a center portion of the pressure sensor unit 110, the constrained portion is reduced and an effect of suppressing the deformation of the pressure sensor unit 110 may be obtained. As a result, deformation of the diaphragm 111a of the pressure sensor unit 110 due to temperature change like that described above is suppressed and thus, an effect of suppressing deterioration of the accuracy of the sensor output may be expected.

However, as described, in a configuration in which only a small region of the center portion of the pressure sensor unit 110 is adhered, a gap occurs between the resin case 101 and the bottom surface of the pressure sensor unit 110. In an instance in which the protective gel 106 is applied when this gap is present, a problem arises in that air bubbles 131 occur in the gap. Before curing, while defoaming to remove the air bubbles 131 by vacuum is performed after the gel 106 is applied, the air bubbles 131 occurring farther away from the ends of the bottom surface of the pressure sensor unit 110 may remain even after the defoaming. Since the gel 106 is permeable to gas to a certain extent, the size of the air bubbles 131 formed at the bottom surface of the pressure sensor unit 110 may increase due to an application of pressure post-market, etc., and if the size of the air bubbles 131 increases beyond a certain level, a problem arises in that the bonding wires 105 connecting the semiconductor pressure sensor chip 111 and the resin case 101 are compressed, causing the bonding wires 105 to be disconnected.

The present disclosure provides a pressure sensor device and a method of manufacturing a pressure sensor device that suppress the occurrence of air bubbles and may reduce the possibility a defect occurs such as wire breakage due to the growth of the air bubbles.

Embodiments of a pressure sensor device and a method of manufacturing a pressure sensor device according to the present disclosure are described in detail with reference to the accompanying drawings. In the description and the accompanying drawings of the embodiments, components that are the same are given the same reference numerals and are not repeatedly described.

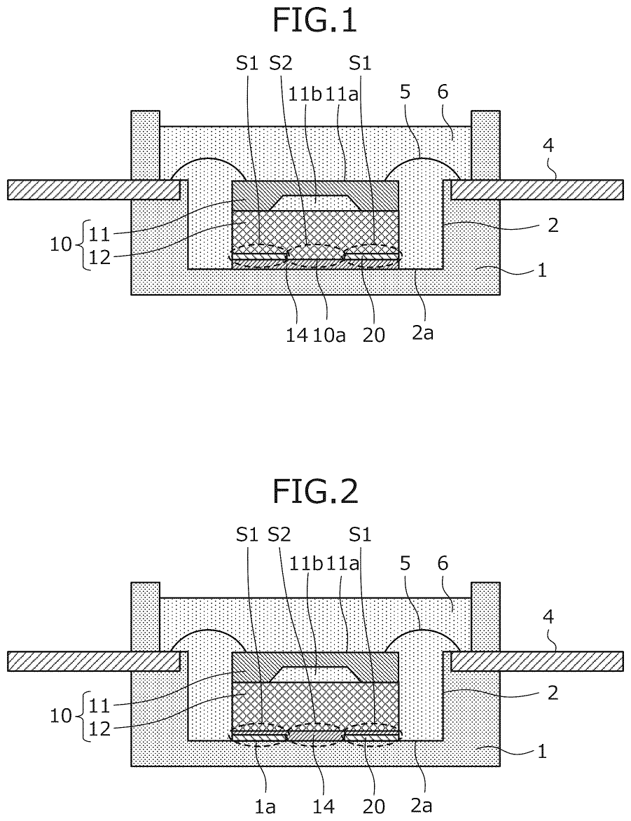

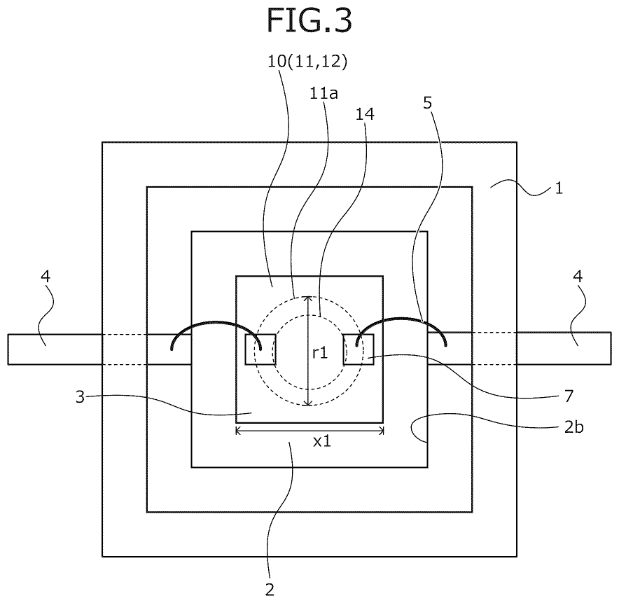

A structure of the semiconductor pressure sensor device according to an embodiment is described. FIGS. 1 and 2 are cross-sectional views depicting the structure of the semiconductor pressure sensor device according to the embodiment and FIG. 3 is a plan view depicting a layout when the semiconductor pressure sensor device in FIGS. 1 and 2 is viewed from a top thereof. The semiconductor pressure sensor device depicted in FIGS. 1, 2, and 3 includes a resin case 1, external-lead terminals, hereinafter, simply “lead terminals” (lead frame) 4, bonding wires 5, a protective gel (hereinafter, may be indicated as simply “gel”) 6, and a pressure sensor unit 10.

The resin case 1 is a housing container body that houses the pressure sensor unit 10; the resin case 1 has therein a concave sensor mounting portion 2 where the pressure sensor unit 10 is housed. The resin case 1, for example, is formed by insert molding by which the lead terminals 4 are integrated using a predetermined mold. A first end of each of the lead terminals 4 is exposed inside the resin case 1 while a second end thereof is exposed outside of the resin case 1. While FIG. 1 depicts an instance in which the second end of each of the lead terminals 4 protrudes outside from a side surface of the resin case 1, arrangement of the lead terminals 4 may be variously changed.

The sensor mounting portion 2, for example, is integrally molded with the resin case 1. The sensor mounting portion 2 suffices to be large enough to house the pressure sensor unit 10 and the shape of the sensor mounting portion 2 in a plan view may be variously changed. While FIG. 3 depicts an instance in which the shape of the sensor mounting portion 2 is substantially rectangular in a plan view, the shape thereof may be, for example, substantially circular or substantially elliptical in a plan view. In an instance in which the shape of the sensor mounting portion 2 is, for example, substantially circular or substantially elliptical in a plan view, during molding of the resin case 1, there are no corners, which are difficult for the resin to flow into and thus, molding defects of the resin case 1 may be suppressed.

The pressure sensor unit 10 is adhered to the bottom of the sensor mounting portion 2 by an adhesive 14 so that the pressure sensor unit 10 is held horizontally with respect to the bottom of the sensor mounting portion 2 and apart from the sidewalls of the sensor mounting portion 2. The pressure sensor unit 10 includes a semiconductor pressure sensor chip 11 and a pedestal member 12. The pressure sensor unit 10 has a structure in which the semiconductor pressure sensor chip 11 is bonded to the surface of a first end of the pedestal member 12 and a portion of the pedestal member 12 at the surface of a second end thereof, the portion being toward a center of the pedestal member 12, is die bonded (fixed) to a bottom 2a of the sensor mounting portion 2 via the adhesive 14. Further, the pressure sensor unit 10 is disposed apart from the sidewalls of the sensor mounting portion 2. Toward a center of the pressure sensor unit 10 (center side of the semiconductor pressure sensor chip 11 and the pedestal member 12) is defined as “inward” while toward an outer peripheral portion of the pressure sensor unit 10 (end side of the semiconductor pressure sensor chip 11 and the pedestal member 12) is defined as “outward”.

The semiconductor pressure sensor chip 11 includes a diaphragm (pressure sensor) 11a that bends due to pressure, a resistance bridge configured by a gauge resistor (not depicted), and an arithmetic circuit unit (not depicted) for amplifying and compensating output of the resistance bridge; the semiconductor pressure sensor chip 11 is a silicon (Si) chip that converts deformation of the diaphragm 11a into an electrical signal. In FIGS. 1, 2, and 3, the gauge resistor is not depicted. The semiconductor pressure sensor chip 11, for example, is electrostatically bonded (anodic bonded) to the surface of the first end of the pedestal member 12 so that a concave portion 11b formed in a portion where the diaphragm 11a is disposed is covered by the pedestal member 12.

The diaphragm 11a is a portion of the semiconductor pressure sensor chip 11 and, for example, is thinner due to the concave portion 11b provided in the center of the back surface, the concave portion 11b having a substantially circular columnar shape. The diaphragm 11a, for example, has a circular shape in a plan view. In FIG. 3, the diaphragm 11a is indicated by a dashed line and reference character “r1” indicates a diameter of the diaphragm 11a. While a thickness of the diaphragm 11a differs depending on the pressure range measured, the thickness is, for example, about a few dozen μm. The pedestal member 12, for example, is made of heat-resistant glass. A portion of the pedestal member 12 at the surface of the second end thereof, the portion being toward the center of the pedestal member 12, is die-bonded to the bottom 2a of the sensor mounting portion 2 via the adhesive 14. In FIG. 3, reference character “x1” indicates length of one side of the surface of the second end of the pedestal member 12 (the bottom surface of the pressure sensor unit 10).

The adhesive 14 is present between an entire area the surface of the second end of the pedestal member 12 and the bottom 2a of the sensor mounting portion 2; a surface area of the adhesive 14 is about a same as a surface area of the surface of the second end of the pedestal member 12. The surface area of the adhesive 14 is an area of an interface between the adhesive 14 and the surface of the second end of the pedestal member 12.

The adhesive 14, for example, contains a polymeric material that does not contain free oils. A free oil is an additive for adjusting a physical property such as elastic modulus, penetration, and hardness. The adhesive 14 is formed using an adhesive that does not contain free oils and thus, when the pressure sensor unit 10 is die-bonded to the bottom of the sensor mounting portion 2, wet spreading of the adhesive 14 is suppressed and the adhesive 14 may be disposed within a predetermined range.

In particular, wet spreading is suppressed by surface tension in a state in which the adhesive 14 is sandwiched between the bottom 2a of the sensor mounting portion 2 and the pressure sensor unit 10. Thus, viscosity of the adhesive 14 suffices to be high enough to an extent that wet spreading of the adhesive 14 may be suppressed within a predetermined time that it takes for the adhesive 14 to be sandwiched between the pressure sensor unit 10 and the bottom 2a of the sensor mounting portion 2 (for example, about 20 seconds) after the adhesive 14 is applied in substantially a center of the bottom 2a of the sensor mounting portion 2 and the pressure sensor unit 10 is placed on the adhesive 14. More specifically, the viscosity of the adhesive 14, for example, may be about 5 Pa·s (Pascal-seconds) or more at 25 degrees C. The adhesive 14, for example, may be an inexpensive silicone-based adhesive or a fluorine-based adhesive with high chemical resistance.

The adhesive 14 is brought into contact with the pressure sensor unit 10 and the bottom 2a of the sensor mounting portion 2 and within a predetermined time, the pressure sensor unit 10 is housed inside the resin case 1 so that the adhesive 14 is sandwiched between the pressure sensor unit 10 and the bottom 2a of the sensor mounting portion 2. Subsequently, the adhesive 14 sandwiched between the pressure sensor unit 10 and the bottom 2a of the sensor mounting portion 2 is cured, whereby the pressure sensor unit 10 and the bottom 2a of the sensor mounting portion 2 are die-bonded via the adhesive 14. The adhesive 14 of the viscosity described above is used, whereby a side surface of the adhesive 14, for example, is orthogonal to the surface of the second end of the pedestal member 12 or is curved so as to protrude inwardly or outwardly.

The resistance bridge is a bridge circuit in which multiple gauge resistors (semiconductor strain gauges) formed of a material having a piezoresistive effect (for example, a diffused region formed in the diaphragm 11a by ion implantation) are bridge-connected. The gauge resistors (not depicted) are disposed at a front side of the semiconductor pressure sensor chip 11. The arithmetic circuit unit, for example, is disposed in a portion of the semiconductor pressure sensor chip 11 excluding the diaphragm 11a (i.e., in the semiconductor pressure sensor chip 11, an outer peripheral portion thereof surrounding a periphery of the diaphragm 11a).

Configuration may be such that the arithmetic circuit unit is not integrated with the semiconductor pressure sensor chip 11. In this case, the arithmetic circuit unit is formed in another semiconductor chip (not depicted) excluding the semiconductor pressure sensor chip 11. The other semiconductor chip in which the arithmetic circuit unit is disposed may be housed in the sensor mounting portion 2 together with the semiconductor pressure sensor chip 11 or may be disposed outside of the semiconductor pressure sensor device. In either case, the other semiconductor chip in which the arithmetic circuit unit is disposed is electrically connected to the semiconductor pressure sensor chip 11. An electrode pad of the other semiconductor chip in which the arithmetic circuit unit is disposed is electrically connected to an electrode pad 7 on the front surface of the semiconductor pressure sensor chip 11 by the lead terminals 4.

The electrode pad 7 on the front surface of the semiconductor pressure sensor chip 11 is electrically connected to the lead terminals 4 via the bonding wires 5. The pressure sensor unit 10 (the semiconductor pressure sensor chip 11), the portions of the lead terminals 4 exposed inside the resin case 1, and the bonding wires 5 are embedded in the gel 6 that fills the sensor mounting portion 2 and are protected by the gel 6 from adhesion of contaminants contained in the pressure medium subject to measurement.

The protective gel 6 is a pressure medium that transmits pressure to the pressure sensor unit 10. When stress or atmospheric pressure (1 atmosphere) applied to the gel 6 is higher than normal (displacement of the diaphragm 11a is zero), the diaphragm 11a is pushed toward the pedestal member 12, whereby the gauge resistors are compressed, and the resistance value of the gauge resistors increases. On the other hand, when stress or atmospheric pressure applied to the gel 6 is lower than normal, the diaphragm 11a and the gauge resistors are pulled in a direction away from the pedestal member 12 and the resistance values of the gauge resistors decreases.

The absolute value of the displacement of the height positions of the diaphragm 11a that has been subjected to pressure, for example, is about 20 nm to 30 nm. When the height position of the diaphragm 11a has been displaced, the arithmetic circuit unit obtains the resistance value of the gauge resistors corresponding to the displacement of the height position of the diaphragm 11a. Additionally, the arithmetic circuit unit calculates voltage corresponding to the obtained resistance values of the gauge resistors, based on, for example, temperature-corrected output characteristics of the semiconductor pressure sensor chip 11 obtained in advance, and outputs the calculation result as an electrical signal to an external destination.

In the embodiment, a region of the bottom 2a of the sensor mounting portion 2 of the resin case 1 facing the bottom surface of the pressure sensor unit 10 constitutes an adhesion region 1a of the resin case 1. Further, the bottom surface of the pressure sensor unit 10 facing the bottom 2a of the sensor mounting portion 2 of the resin case 1 constitutes an adhesion region 10a of the pressure sensor unit 10. The resin case 1 and the pressure sensor unit 10 each have a region center portion S2 and a region peripheral portion S1 that are mutually exclusive, the resin case 1 and the pressure sensor unit 10 being fixed to each other at said region center portions S2 by an adhesive and are not fixed to each other at said region peripheral portions S1 by the adhesive. By performing a treatment to make adhesion to the adhesion region 1a or the adhesion region 10a of the region peripheral portion S1 difficult, an adhesion resistant region 20 is formed. As described, the region peripheral portion S1 between the adhesion region 1a and the adhesion region 10a has a structure in which the adhesive 14 is present but not does not adhere the adhesion region 1a and the adhesion region 10a to each other. FIG. 1 depicts an instance in which the adhesion resistant region 20 is formed in the adhesion region 10a of the pressure sensor unit 10 and FIG. 2 depicts an instance in which the adhesion resistant region 20 is formed in the adhesion region 1a of the resin case 1. Here, as the treatment for creating the adhesion resistant region 20, for example, a commercially available mold release agent containing a fluororesin, silicone, or the like as a main component may be used. A mold release agent is a chemical used to improve mold separation of products produced and manufactured by molding and has a function of reducing the friction force between substances. The area of the adhesion region 10a where the resin case 1 and the pressure sensor unit 10 are adhered to each other by the adhesive 14 of the region center portion S2 is, for example, at least 5% of the area of the bottom surface of the pressure sensor unit 10 and preferably, may be not more than 200% of the area of the diaphragm 11a. At least 5% of the area of the bottom surface of the pressure sensor unit 10 is set, whereby the pressure sensor unit 10 may be assuredly fixed to the resin case and not more than 200% of the area of the diaphragm 11a is set, whereby fluctuation of output voltage may be suppressed over time from an initial stage.

With the structure above, the pressure sensor unit 10 and the resin case 1 are constrained only in a small area of the region center portion S2 and thus, thermal stress due to the linear expansion difference between the pressure sensor unit 10 and the resin case 1 due to temperature change is reduced and as a result, deformation of the diaphragm 11a of the pressure sensor unit 10 is reduced. As a result, deterioration of the accuracy of the pressure sensor may be suppressed. On the other hand, in the structure, the adhesive 14 is present in an entire area between the adhesion region 1a of the concave portion of the sensor mounting portion 2 of the resin case 1 and the adhesion region 10a of the pressure sensor unit 10, whereby during application of the gel 6, the occurrence of air bubbles between the adhesion region 1a and the adhesion region 10a is eliminated. The occurrence of air bubbles between the adhesion region 1a and the adhesion region 10a is suppressed and thus, the possibility of a defect post-market such as disconnection of the bonding wires 5 due to the growth of air bubbles caused pressure applied thereto may be reduced. As a result, it is possible to both reduce thermal stress by constraining only the region center portion S2 and to suppress the generation of air bubbles by not creating a gap. As a result, it is possible to both reduce thermal stress by restraining only the center of the region S1 and suppress the generation of bubbles by not creating a gap.

Next, a method of manufacturing the semiconductor pressure sensor device according to the embodiment is described by first and second examples. Assembly of the pressure sensor unit 10 and the resin case 1 is performed as described in the first and second examples, whereby the region S1 other than the center of the pressure sensor unit 10 may be formed having a structure in which the adhesive 14 is present but not does not adhere the pressure sensor unit 10 and the resin case 1 to each other.

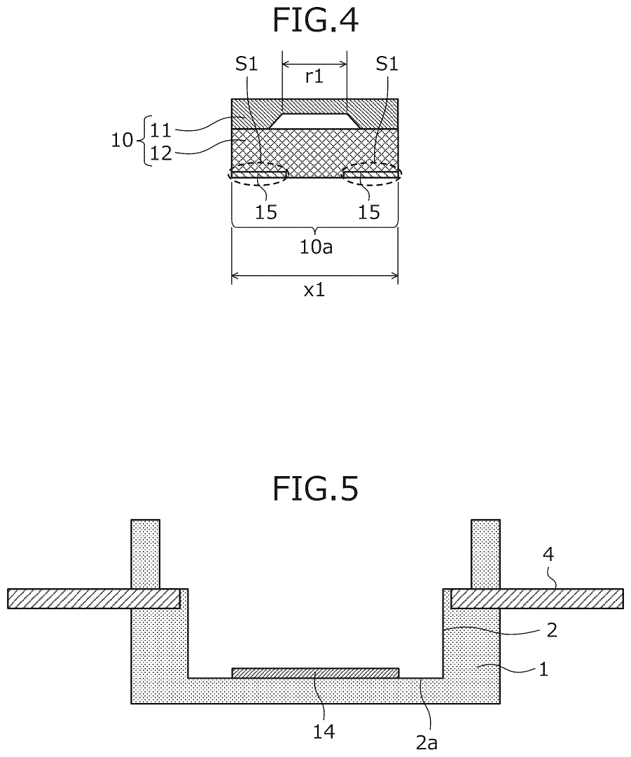

The first example is an example of the semiconductor pressure sensor device depicted in FIG. 1. FIGS. 4, 5, 6, and 7 are cross-sectional views schematically depicting states of the semiconductor pressure sensor device of the first example during manufacture. In the first example, first, as depicted in FIG. 4, a mold release agent 15 is applied to the bottom surface of the pressure sensor unit 10. At this time, the mold release agent 15 is applied only to the region peripheral portion S1 and a mask is used so that the mold release agent 15 is not applied to a circular region having a diameter of 1 mm at the center of the bottom surface of the pressure sensor unit 10 (first process). The region to which the mold release agent 15 is applied constitutes the adhesion resistant region 20 in FIG. 1.

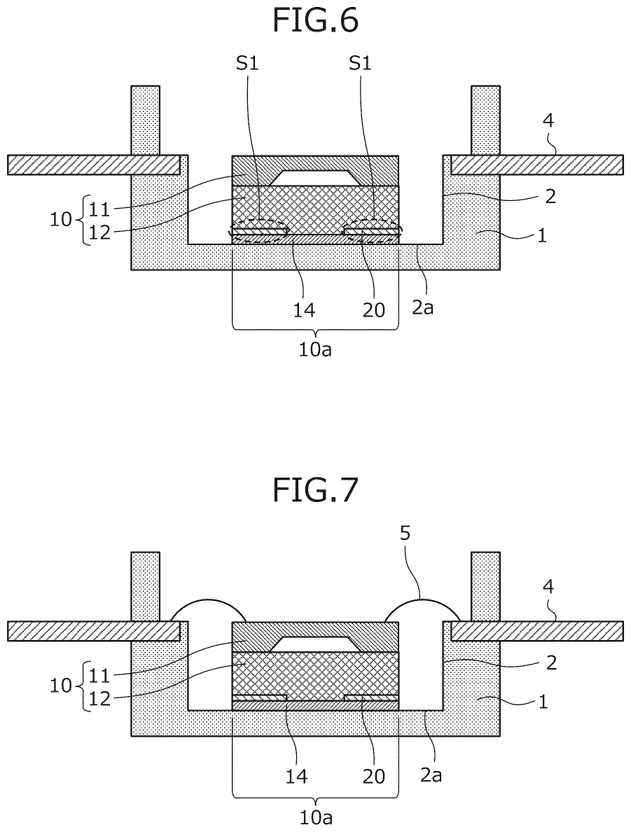

Next, as depicted in FIG. 5, at the bottom 2a of the sensor mounting portion 2 of the resin case 1 where the pressure sensor unit 10 is to be mounted, the adhesive 14 is applied to a region at least equal to the size of the bottom surface of the pressure sensor unit 10 (second process). Next, as depicted in FIG. 6, the pressure sensor unit 10 is mounted at a predetermined position in the resin case 1 where the adhesive 14 has been applied and a predetermined temperature is applied, whereby the adhesive 14 is cured (third process).

The region where the pressure sensor unit 10 and the bottom 2a of the sensor mounting portion 2 of the resin case 1 are fixed to each other by the adhesive 14 is 0.79 mm². While an instance in which at the bottom 2a of the sensor mounting portion 2 of the resin case 1, the adhesive 14 is applied to a region that is at least equal to the size of the bottom surface of the pressure sensor unit 10 is described, the adhesive 14 may be applied to the bottom surface of the pressure sensor unit 10.

Next, as depicted in FIG. 7, while the adhesive 14 is cured, the lead terminals 4 between the pressure sensor unit 10 and the resin case 1 are connected by the bonding wires 5 (fourth process). Next, the protective gel 6 is injected into the resin case 1 in which the pressure sensor unit 10 is mounted (fifth process). Next, the resin case 1 in which the pressure sensor unit 10 has been mounted and into which the protective gel 6 has been injected is exposed to a vacuum of 500 Pa to thereby perform defoaming of the gel 6 (sixth process). After the defoaming, a predetermined temperature is applied, thereby curing the gel 6 (seventh process). Thus, the semiconductor pressure sensor device depicted in FIG. 1 is completed.

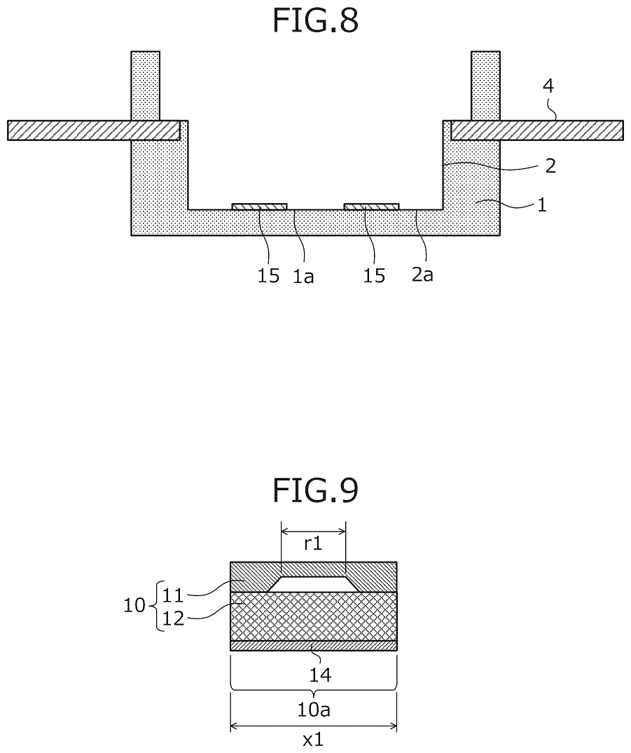

The second example is an example of the semiconductor pressure sensor device depicted in FIG. 2. FIGS. 8, 9, and 10 are cross-sectional views schematically depicting states of the semiconductor pressure sensor device of the second example during manufacture. In the second example, first, as depicted in FIG. 8, the mold release agent 15 is applied to the adhesion region 1a of the resin case 1 in which the pressure sensor unit 10 is to be mounted. At this time, the mold release agent 15 is applied only to the region peripheral portion S1 and a circular region having a diameter of 1 mm at the center is masked so that the mold release agent 15 is not applied thereto (first process). The region to which the mold release agent 15 is applied constitutes the adhesion resistant region 20 in FIG. 2.

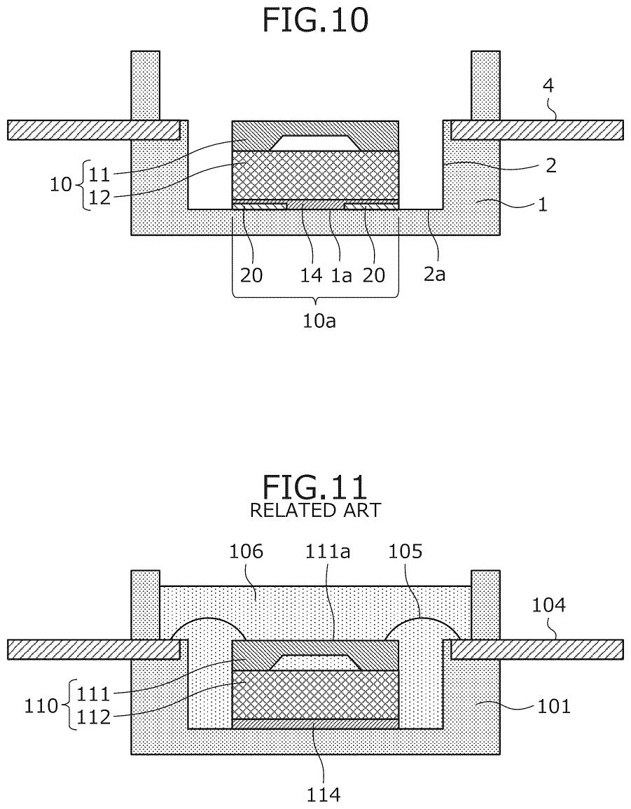

Next, as depicted in FIG. 9, the adhesive 14 is applied to the bottom surface of the adhesion region 10a of the pressure sensor unit 10, in a predetermined range (second process). Next, as depicted in FIG. 10, the pressure sensor unit 10 to which the adhesive 14 has been applied is mounted to a predetermined position in the resin case 1 and a predetermined temperature is applied thereby curing the adhesive 14 (third process). Thereafter, processes the same as those in the first example are performed, whereby the semiconductor pressure sensor device depicted in FIG. 2 is completed.

The region where the pressure sensor unit 10 and the bottom 2a of the sensor mounting portion 2 of the resin case 1 are fixed to each other by the adhesive 14 is 0.79 mm². While an instance in which the adhesive 14 is applied to the pressure sensor unit 10 is described, the adhesive 14 may be applied to the bottom 2a of the sensor mounting portion 2 of the resin case 1, the adhesive 14 being applied to a region of the bottom 2a at least equal to the size of the bottom surface of the pressure sensor unit 10.

In the first and second examples, the bottom surface of the pressure sensor unit 10 has a square shape, the length x1 of one side is 3 mm, and the diameter r1 of the diaphragm 11a is 1.3 mm. Therefore, the area of the pressure sensor unit 10 adhered to the bottom of the concave portion of the sensor mounting portion 2 of the resin case 1 by the adhesive 14 is at least 0.45 mm², which is 5% of the area 9.0 mm² of the bottom surface of the pressure sensor unit 10 and preferably, may be not more than 2.65 mm², which is 200% of the area 1.327 mm² of the diaphragm 11a.

As described, according to the embodiments, in the semiconductor pressure sensor device, the adhesion resistant region is formed in the adhesion region (bottom surface) of the pressure sensor unit. As a result, the pressure sensor unit and the resin case are constrained only in a small region of the region center portion and thus, thermal stress due to the linear expansion difference between the pressure sensor unit and the resin case due to temperature variation is reduced and deformation of the diaphragm of the pressure sensor unit is reduced. As a result, deterioration of the accuracy of the pressure sensor may be suppressed. Furthermore, in the structure, the adhesive is present in an entire area of the bottom surface of the pressure sensor unit and thus, the occurrence of air bubbles during gel application is eliminated and the possibility that a defect such as wire breakage occurs post-market due to growth of the air bubbles caused by application of pressure, etc. may be reduced.

In the foregoing, the present disclosure is not limited to the embodiments and various modifications within a range not departing from the spirit of the disclosure are possible. For example, dimensions of regions, materials of the resin case, the lead terminals, the bonding wire, the gel, the adhesive, and the like may be variously changed according to necessary specifications.

According to the disclosure, the pressure sensor unit and the resin case are constrained only in a small region of the region center portion and thus, thermal stress due to the linear expansion difference between the pressure sensor unit and the resin case due to temperature variation is reduced and deformation of the diaphragm of the pressure sensor unit is reduced. As a result, deterioration of the accuracy of the sensor may be suppressed; the occurrence of air bubbles during gel application is eliminated; and the possibility that a defect such as wire breakage occurs post-market due to growth of the air bubbles caused by application of pressure, etc. may be reduced.

The pressure sensor device and the method of manufacturing a pressure sensor device according to the present disclosure achieve an effect in that the occurrence of air bubbles is suppressed and the possibility a defect such as wire breakage occurs due to growth of the air bubbles may be reduced.

As described, the pressure sensor device and the method of manufacturing a pressure sensor device according to the disclosure are useful for semiconductor pressure sensor devices in which a sensor unit is mounted in a resin case via an adhesive.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A pressure sensor device, comprising:
a sensor unit having:
a sensor chip having a diaphragm, the sensor chip being configured to convert pressure caused by deformation of the diaphragm into an electrical signal, and
a member supporting the sensor chip; and
a resin case housing the sensor unit, wherein
the sensor unit is so disposed that a bottom surface thereof faces the resin case with an adhesive disposed therebetween,
the bottom surface of the sensor unit has a center region and a peripheral region that are mutually exclusive,
the center region of the bottom surface of the sensor unit is fixed to the resin case by the adhesive between the center region and the resin case, and
the peripheral region of the bottom surface of the sensor unit is not fixed to the resin case by the adhesive between the peripheral region and the resin case.

2. The pressure sensor device according to claim 1, wherein the adhesive and the peripheral region of the bottom surface of the sensor unit have a mold release agent applied therebetween.

3. The pressure sensor device according to claim 2, wherein the mold release agent contains a fluororesin as a main constituent.

4. The pressure sensor device according to claim 1, wherein
the resin case has a peripheral region that faces the peripheral region of the bottom surface of the sensor unit, and
the adhesive and the peripheral region of the resin case have a mold release agent applied therebetween.

5. The pressure sensor device according to claim 4, wherein the mold release agent contains a fluororesin as a main constituent.

6. The pressure sensor device according to claim 1, wherein the center region of the bottom surface of the sensor unit has an area that is at least 5% of an area of the bottom surface but not more than 200% of an area of the diaphragm.

7. A method of manufacturing a pressure sensor device that includes
a sensor unit, having:
a sensor chip having a diaphragm, the sensor chip being configured to convert pressure caused by deformation of the diaphragm into an electrical signal, and
a member that supports the sensor chip,
the sensor unit having a bottom surface including a center region and a peripheral region that are mutually exclusive; and
a resin case housing the sensor unit, the resin case having a lead terminal,
the method comprising:
applying a mold release agent only to the peripheral region of the bottom surface of the sensor unit;
applying an adhesive of a predetermined amount to the resin case or the bottom surface of the sensor unit;
mounting the sensor unit at a predetermined position in the resin case, applying a first predetermined temperature with the adhesive being present in an entire area between the bottom surface of the sensor unit and the resin case, to thereby cure the adhesive;
connecting the sensor unit and the lead terminal of the resin case by a bonding wire;
injecting a protective gel into the resin case;
exposing the resin case to a vacuum environment, to thereby defoam the protective gel; and
applying a second predetermined temperature to the resin case, to thereby cure the protective gel.

8. The method according to claim 7, wherein the center region of the bottom surface of the sensor unit has an area that is at least 5% of an area of the bottom surface of the sensor unit but is no more than 200% of an area of the diaphragm.

9. A method of manufacturing a pressure sensor device that includes
a sensor unit, having:
a sensor chip having a diaphragm, the sensor chip being configured to convert pressure caused by deformation of the diaphragm into an electrical signal, and
a member that supports the sensor chip,
the sensor unit having a bottom surface including a center region and a peripheral region that are mutually exclusive; and
a resin case housing the sensor unit, the resin case having a lead terminal, and a center region and a peripheral region respectively corresponding to the center region and the peripheral region of the bottom surface of the sensor unit,
the method comprising:
applying a mold release agent only to the peripheral region of the resin case;
applying a predetermined amount of an adhesive to the resin case or the bottom surface of the sensor unit;
mounting the sensor unit at a predetermined position in the resin case, such that the peripheral region of the resin case faces the peripheral region of the bottom surface of the sensor unit, applying a first predetermined temperature with the adhesive being present in an entire area between the bottom surface of the sensor unit and the resin case, to thereby cure the adhesive;
connecting the sensor unit and the lead terminal of the resin case by a bonding wire;
injecting a protective gel into the resin case;
exposing the resin case to a vacuum environment, to thereby defoam the protective gel; and
applying a second predetermined temperature to the resin case, to there cure the protective gel.

10. The method according to claim 9, wherein
the center region of the resin case faces the center region of the bottom surface of the sensor unit, and
an area of the center region of the resin case is at least 5% of an area of the bottom surface of the sensor unit but is not more than 200% of an area of the diaphragm.
